(19) United States
(12) Patent Application Publication
(10) Pub. No.: US 2010/0189600 A1
(43) Pub. Date: Jul. 29, 2010

(54) MONITOR FOR OPTICAL DETECTION OF ORGANIC ANALYTES

(75) Inventors: John C. Hulteen, Afton, MN (US); Neal A. Rakow, Woodbury, MN (US); Michael S. Wendland, North St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/688,988

(22) Filed: Jan. 18, 2010

Related U.S. Application Data
(60) Provisional application No. 61/148,228, filed on Jan. 29, 2009.

(51) Int. Cl. G01N 21/62; G01N 31/22

(52) U.S. Cl. 422/58

(57) ABSTRACT

Herein is disclosed a monitor that can be used to detect and/or monitor the presence of organic analytes and that may be used for personal monitoring and/or for area monitoring. The monitor comprises at least one optically interrogatable sensing element that is responsive to the presence of an analyte of interest.

The monitor may comprise various features, components and functionalities to enhance the performance of the sensing element, including for example protective layers, spacing elements, viewing angle control features, and barrier layers.

### CROSS REFERENCE TO RELATED APPLICATIONS

This application claims the benefit of U.S. Provisional Application No. 61/148,228, filed Jan. 29, 2009, which is incorporated herein by reference in its entirety.

### BACKGROUND

The ability to detect chemical analytes, especially organic chemical analytes, is important in many applications, including environmental monitoring and the like. Such detection and/or monitoring of organic molecules may find particular use in, for example, personal monitors (e.g., that can be worn or carried by a person), and/or area monitors (e.g., that can be placed in a desired environment).

Many methods for the detection of chemical analytes have been developed, for example optical, gravimetric, microelectromechanical, and so on. Among the optical methods available for chemical sensing, colorimetric techniques remain advantageous in that the human eye can be used for signal transduction, rather than extensive instrumentation. Though colorimetric sensors currently exist for a range of analytes, most are based upon employing dyes or colored chemical indicators for detection. Such compounds are typically selective, meaning that multiple sensors may be necessary in order to detect various classes of compounds. Moreover, many of these systems have lifetime limitation issues, due to photo-bleaching or undesirable side reactions. Other optical sensing techniques, such as surface plasmon resonance and spectral interferometry, require substantial signal transduction hardware to provide response, and thus may not be useful for simple visual indication.

### SUMMARY OF THE INVENTION

Herein is disclosed a monitor that can be used to detect the presence of an organic analyte in air. The monitor may comprise a main body and at least one sensing element.

The at least one sensing element is responsive to the presence of an analyte of interest and may be interrogated optically, e.g., by visual observation by a person. The sensing element may contain at least one layer that is responsive to the presence of an analyte, at least one layer that is reflective, and at least one layer that is semireflective, the layers combining to comprise a so-called interference filter whose perceived color (e.g., as observed by a user) may change in the presence of an analyte or upon a change in the concentration of an analyte. In various embodiments, the reflective layer, or the semireflective layer, may be analyte-permeable so as to allow an analyte to reach the analyte-responsive layer.

In one aspect, disclosed herein is a monitor for detecting the presence of an organic analyte in ambient air, comprising a main body comprising at least one sensing element, the sensing element comprising at least a semireflective layer, an analyte-permeable reflective layer, and an analyte-responsive layer located therebetween, wherein the sensing element is configured such that when the monitor is placed adjacent a mounting surface the analyte-permeable reflective layer faces toward the mounting surface, and wherein the monitor comprises at least one spacing element arranged such that when the monitor is placed adjacent a mounting surface at least a portion of at least one spacing element comes in contact with the mounting surface and prevents the sensing element from coming into contact with the mounting surface.

In another aspect, disclosed herein is a monitor for detecting the presence of an organic analyte in ambient air, comprising a main body comprising at least one sensing element, the sensing element comprising at least a semireflective layer, an analyte-permeable reflective layer, and an analyte-responsive layer located therebetween, wherein the sensing element is configured such that when the monitor is placed adjacent a mounting surface the analyte-permeable reflective layer faces toward the mounting surface, and wherein the monitor comprises at least one protective layer adjacent the analyte-permeable reflective layer and which is permeable to gases and vapors but which substantially prevents the passage of liquids.

In another aspect, disclosed herein is a monitor for detecting the presence of an organic analyte in air, comprising a main body comprising at least one sensing element, the sensing element comprising at least a semireflective layer, an analyte-permeable reflective layer, and an analyte-responsive layer located therebetween, wherein the monitor comprises a removable barrier layer located at least adjacent to, and in overlapping relation with, the analyte-permeable reflective layer of the sensing element and that substantially prevents the passage of gases, vapors and liquids into the sensing element.

In another aspect, disclosed herein is a monitor for detecting the presence of an organic analyte in ambient air, comprising a main body comprising at least one sensing element, the sensing element comprising at least a semireflective layer, an analyte-permeable reflective layer, and an analyte-responsive layer located therebetween, wherein the analyte-permeable reflective layer faces away from the main body and the semireflective layer faces toward the main body and is in overlapping relation with an area of the main body that is light-transmissive.

In still another aspect, disclosed herein is a monitor for detecting the presence of an organic analyte in ambient air, comprising a main body comprising at least one sensing element, the sensing element comprising at least a reflective layer, an analyte-permeable semi-reflective layer, and an analyte-responsive layer located therebetween, wherein the sensing element is configured such that when the monitor is placed adjacent a mounting surface the analyte-permeable semireflective layer faces away from the mounting surface, and wherein the monitor comprises a removable barrier layer located at least adjacent to, and in overlapping relation with, the analyte-permeable semireflective layer of the sensing element and that substantially prevents the passage of gases, vapors and liquids into the sensing element.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a perspective view of an exemplary monitor comprising an exemplary sensing element.

FIG. 1A is a side schematic cross sectional view taken along line 1A of FIG. 1.

FIG. 2 is a side schematic cross sectional view of a portion of an exemplary sensing element.

FIG. 3 is a side schematic cross sectional view of a portion of another exemplary sensing element.

FIG. 4 is a side schematic cross sectional view of a portion of an exemplary monitor comprising an exemplary sensing element.

FIG. 5 is a side schematic cross sectional view of a portion of an exemplary sensing element comprising an exemplary protective layer.

FIG. 6 is a side schematic cross sectional view of an exemplary monitor comprising an exemplary spacing element.

FIG. 7 is a side schematic cross sectional view of an exemplary monitor comprising an exemplary spacing element.

FIG. 8 is a top schematic cross sectional view of an exemplary monitor comprising an exemplary spacing element.

FIG. 8A is a side schematic cross sectional view of an exemplary monitor comprising an exemplary spacing element.

FIG. 9 is a perspective view of an exemplary monitor comprising a shaped main body.

FIG. 10 is a side schematic cross sectional view of an exemplary monitor comprising a shaped main body.

FIG. 10A is a perspective view of an exemplary monitor comprising a shaped sensing element.

FIG. 11 is a side schematic cross sectional view of a portion of an exemplary monitor comprising an exemplary sensing element positioned in a recess in the main body of the monitor.

FIG. 12 is a side schematic cross sectional view of a portion of an exemplary monitor comprising an exemplary sensing element positioned in a recess in the main body of the monitor.

FIG. 13 is a side schematic cross sectional view of a portion of an exemplary monitor comprising a main body that comprises an upper portion and a lower portion, with an exemplary sensing element positioned in a recess in the lower portion of the main body and held in place by the upper portion of the main body.

FIG. 14 is a side schematic cross sectional view of a portion of an exemplary monitor comprising a main body that comprises an upper portion and a lower portion, with an exemplary sensing element positioned in a recess in the lower portion of the main body and held in place by the upper portion of the main body, with the monitor also comprising an exemplary protective layer and an exemplary spacing element.

FIG. 15 is a side schematic cross sectional view of an exemplary monitor comprising an exemplary sensing element and with an exemplary barrier layer.

FIG. 16 is a side schematic cross sectional view of an exemplary monitor comprising an exemplary sensing element and with an exemplary barrier layer that extends to the outward surface of the monitor.

Like reference symbols in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, “bottom”, “upper”, “lower”, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

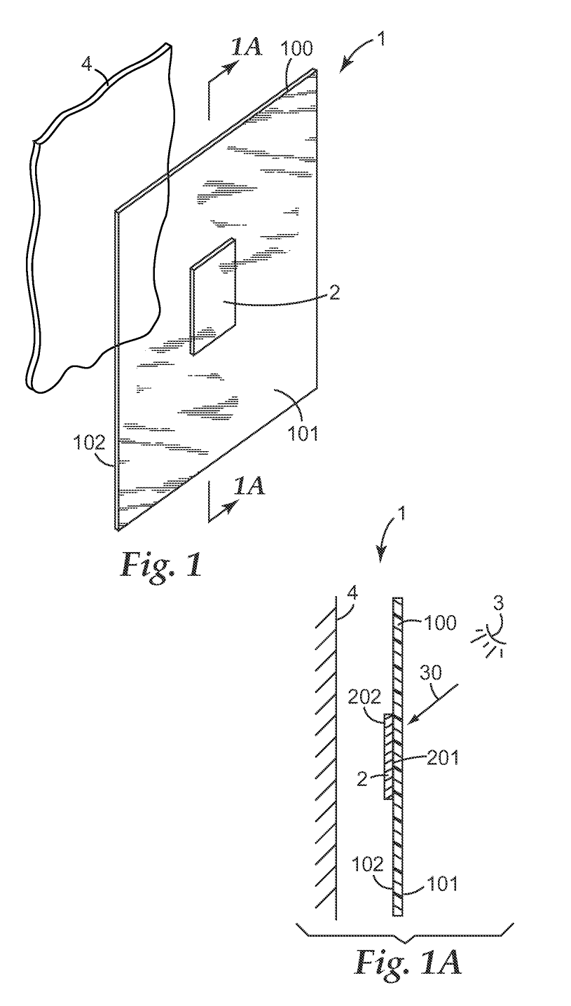

Shown in perspective view in FIG. 1 and in side cross sectional view in FIG. 1A is an exemplary monitor 1 comprising at least one sensing element 2. Monitor 1 may comprise main body 100 which may comprise any suitable shape or form. Often, main body 100 may comprise a thickness that is significantly less than its length and/or breadth, as in FIGS. 1 and 1A). Main body 100 may have various features and components in order to accommodate and promote the functioning of sensing element 2, as discussed in detail herein.

Monitor 1 may be portable and as such may be used for personal monitoring. As such, monitor 1 may be worn by a person such as by being attached (e.g., by a clip, loop, strap, sleeve, lanyard, pocket protector, etc., not shown in FIG. 1) to the persons' clothing or otherwise worn or carried, e.g. as a badge. Monitor 1 may also be used for area monitoring, for example by being placed into an environment (e.g., a room, vehicle, etc.), which may be indoors or outdoors, in which it is desired to monitor the presence of an analyte.

Monitor 1 may be placed adjacent to a mounting surface 4 (which may be a portion of the body and/or clothing of a person, in the case of a personal monitor; a wall or other room surface in the case of an area monitor, etc.). In this context, the term adjacent means near or close to, and may involve, but does not require, actual contact. Monitor 1 may be attached directly to mounting surface 4, may be indirectly attached to mounting surface 4 (e.g., by means of a hook or other attachment device), or may simply reside near mounting surface 4 and/or in contact with mounting surface 4, without necessarily being directly or indirectly attached to mounting surface 4 (e.g., monitor 1 may comprise a badge that hangs from a lanyard around the neck of a person so as to be positioned near or in contact with the torso of the person). With respect to mounting surface 4, main body 100 of monitor 1 may comprise first major surface 101 that faces outward (away from mounting surface 4) and second major surface 102 (that faces toward mounting surface 4). Although shown as generally planar and smooth in the exemplary illustrations of FIGS. 1 and 1A, first and/or second major surfaces 101 and 102 may comprise one or more features (e.g., recesses, protruding members, posts, etc., as disclosed herein) that deviate from such configurations.

Monitor 1 may be used for the monitoring of a gaseous environment, typically air. In some particular embodiments, monitor 1 may be used for the monitoring of ambient air, which is herein defined as air which is not flowing onto or across sensing element 2 in an airstream. In this context, an airstream is defined herein as air that is moving through the interior of a substantially enclosed device or conduit, motivated by a powered fan or a pump, or by the breathing of a person (such as might be found in a personal respiratory protection device). Thus in this context, an airstream does not encompass such air movements as may be caused by a wearer of monitor 1 moving; nor by such air movements as may be caused in an environment (e.g., a room) by ventilation equipment and the like.

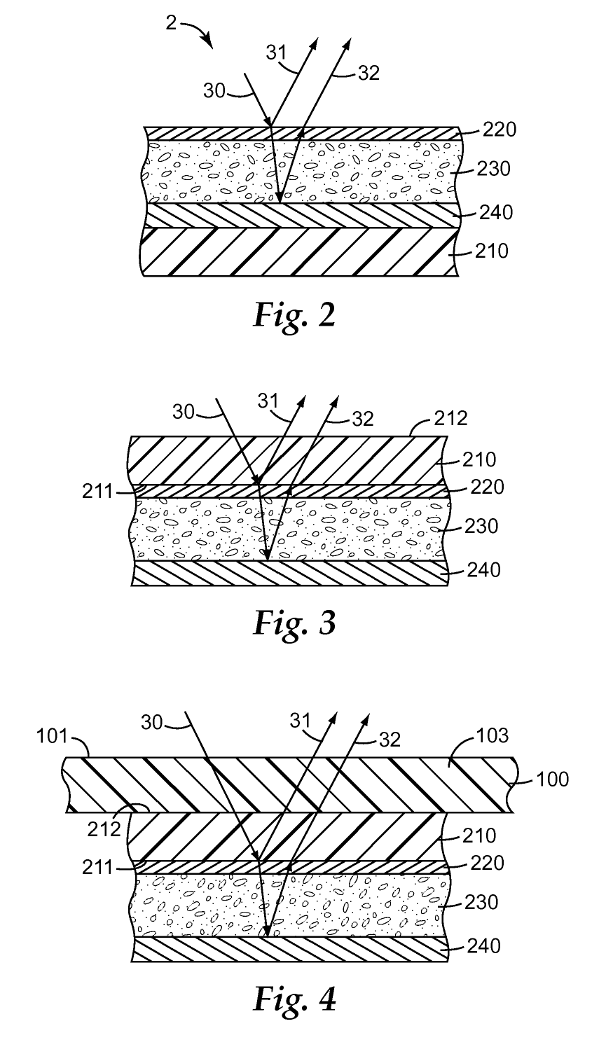

Sensing element 2 may be attached directly or indirectly to monitor 1 (e.g., to main body 100 of monitor 1, and/or to a component of monitor 1 that is attached or connected to main body 100). Sensing element 2 is responsive to the presence of an analyte and may be interrogated optically, e.g., by visual observation by a person. Sensing element 2 relies at least in part on a change in optical reflectance, that is, a change in the wavelength of light reflected by sensing element 2 (e.g., a given viewing angle), in the presence of an analyte and/or upon a change in the concentration of an analyte. Sensing element 2 may contain at least one layer whose optical properties (e.g., optical thickness) are responsive to the presence of an analyte. Sensing element may further contain at least one layer that is reflective. Sensing element 2 may further contain at least one layer that is semireflective. In a particular configuration, sensing element 2 may comprise an analyte-responsive layer 230 in between a reflective layer 240 and a semireflective layer 220 (the layers combining to comprise a so-called interference filter whose perceived color, e.g., as visually observed, may change in the presence of an analyte or upon a change in the concentration of an analyte) as discussed in detail below with respect to the exemplary embodiments of FIGS. 2 and 3.

Sensing element 2 may be optically interrogated by exposing sensing element 2 to incoming light rays 30 (as shown in FIG. 1A) and observing the light reflected from sensing element 2. A dedicated (external) light source is not needed to provide light rays 30 (although one or more dedicated light sources may be so used if desired). While in FIG. 1A light rays 30 are shown as originating from a single discrete light source 3, in practice ambient light (which may originate from several discrete light sources, from a combination of light from direct sources and from reflected light, from sunlight, etc.) may be used as the source of light rays 30.

In embodiments incorporating the design shown in FIG. 1, sensing element 2 may be positioned on a side of monitor 1 that generally faces toward mounting surface 4 when monitor 1 is placed in position adjacent mounting surface 4. In such case, sensing element 2 may comprise first major surface 201 that may face toward main body 100 of monitor 1 (and may be in contact with at least a portion of main body 100) and major surface 202 that may face generally away from main body 100 of monitor 1. In such an arrangement, analyte may enter sensing element 2 through second major surface 202 of sensing element 2, with sensing element 2 being optically interrogated from the opposite side of monitor 1 (e.g., through first major surface 201 of sensing element 2 and possibly through main body 100 of monitor 1), as discussed in detail below with respect to embodiments of the type shown in FIG. 3. Other arrangements are possible, as discussed herein.

An exemplary sensing element 2 is shown in FIG. 2. In embodiments incorporating this design, sensing element 2 comprises in order semireflective layer 220, analyte-responsive layer 230, reflective layer 240, and substrate 210. In interrogation of sensing element 2, incoming light rays 30 impinge on semireflective layer 220. Some portion of light rays 30 may reflect from semireflective layer 220 as light rays 31. Some portion of light rays 30 may pass through semireflective layer 220 and pass through analyte-responsive layer 230 and be reflected at the interface of analyte-responsive layer 230 and reflective layer 240, to emerge from sensing element 2 as light rays 32. Light rays 31 and 32 may combine to collectively form an interference pattern thus light so reflected from sensing element 2 may comprise a relatively discernible color (e.g., red, green, etc.).

In the exemplary design of FIG. 2, analyte may permeate through semireflective layer 220 to enter analyte-responsive layer 230. This may change the optical properties of layer 230 (e.g., the optical thickness) such that the wavelength of the light reflected from sensing element 2 may change sufficiently to allow the presence of, and/or the concentration of, an analyte to be detected or monitored.

In a embodiments incorporating the design shown in FIG. 2, semireflective layer 220 is analyte-permeable, which property can be provided as discussed later herein, and is in fluid communication with analyte-responsive layer 230, such that analyte can enter layer 230 through layer 220. The outermost surface of semireflective layer 220 thus may comprise major surface 202 of sensing element 2 (unless any additional layers, e.g., protective layers etc., are provided on sensing element 2). In the design of FIG. 2, reflective layer 240 may or may not be analyte-permeable. In the exemplary design of FIG. 2, light may not need to pass through, or interact with, substrate 210, during optical interrogation of sensing element 2, so substrate 210 may not need any particular optical transparency properties.

In an exemplary embodiment, sensing element 2 of FIG. 2 may be produced by depositing reflective layer 240 upon substrate 210, depositing analyte-responsive layer 230 upon reflective layer 240, and depositing analyte-permeable semireflective layer 220 upon analyte-responsive layer 230. The thus-formed sensing element 2 can then be provided on monitor 1 (e.g., by being mounted upon or within, attached to, etc., main body 100 of monitor 1).

Another exemplary sensing element 2 is shown in FIG. 3. In embodiments incorporating the design shown in FIG. 3, sensing element 2 comprises in order (optional) substrate 210, semireflective layer 220, analyte-responsive layer 230, and reflective layer 240. Light rays 30 from light source 3 impinge on and pass through substrate 210. Some portion of light rays 30 may reflect at the interface of substrate 210 and semireflective layer 220 to emerge from sensing element 2 as light rays 31. Some portion of light rays 30 may pass through semireflective layer 220 and pass through analyte-responsive layer 230 and be reflected at the interface of analyte-responsive layer 230 and reflective layer 240, to emerge from sensing element 2 as light rays 32. Light rays 31 and 32 may combine to collectively form an interference pattern thus light so reflected from sensing element 2 may comprise a relatively discernible color (e.g., red, green, etc.).

In the exemplary design of FIG. 3, analyte may permeate through reflective layer 240 to enter analyte-responsive layer 230. This may change the optical properties of layer 230 (e.g., the optical thickness) such that the wavelength of the light reflected from sensing element 2 may change sufficiently to allow the presence of, and/or the concentration of, an analyte to be detected or monitored.

In embodiments incorporating the design shown in FIG. 3, reflective layer 240 is analyte-permeable, which property can be provided through methods discussed later herein, and is in fluid communication with analyte-responsive layer 230. In such embodiments, the outermost surface of reflective layer 240 may comprise major surface 202 of sensing element 2 (unless any additional layers, e.g., protective layers etc., are provided on sensing element 2). In the design of FIG. 3, semireflective layer 220 may or may not be analyte-permeable. In the exemplary design of FIG. 3, light may pass through substrate 210, so substrate 210 should comprise sufficient transparency at the wavelengths of interest for monitoring. In such embodiments substrate 210 comprises first major surface 211 that faces toward the other layers comprising sensing element 2, and second major surface 212 that faces outward, away from the other layers comprising sensing element 2, and that may contact a portion of main body 100 of monitor 1.

In an exemplary embodiment, sensing element 2 of FIG. 3 may be produced by depositing semireflective layer 220 upon first major surface 211 of transparent substrate 210, depositing analyte-responsive layer 230 upon semireflective layer 220, and depositing analyte-permeable reflective layer 240 upon analyte-responsive layer 230. The thus-formed sensing element 2 can then be provided on monitor 1 (e.g., by being mounted upon or within, attached to, etc., main body 100 of monitor 1).

The exemplary embodiments of FIGS. 2 and 3 illustrate two of the possible ways in which sensing element 2 may be configured. In the design of FIG. 2, semireflective layer 220 may be permeable to the analyte, thus the analyte may enter sensing element 2 from the same side as which light rays 30 impinge on sensing element 2. In such a design, sensing element 2 may be conveniently positioned on monitor 1 by way of substrate 210 of sensing element 2 being placed adjacent and/or in contact with major surface 101 of main body 100 of monitor 1 (not shown in any Figure). In the design of FIG. 3, reflective layer 240 may be permeable to the analyte, thus the analyte may enter sensing element 2 from the opposite side from which light rays 30 impinge on sensing element 2. In such a design, sensing element 2 may be conveniently positioned on monitor 1 by way of substrate 210 of sensing element 2 being placed adjacent with main body 100 of monitor 1 and/or in contact with major surface 102 of main body 100 of monitor 1. (A design of this general type is shown in FIGS. 1 and 1A.)

In some embodiments, sensing element 2 may be flexible, bendable, or crimpable. Thus, if desired, sensing element 2 may be positioned on monitor 1 in a nonplanar (e.g., curved) configuration. Such curvature might for example enhance the ability of a user to view sensing element 2 from an optimum viewing angle, and/or to allow a user to view the sensor from a larger range of viewing angles with minimal shift in color.

Properties, methods of making, and the like, of substrate 210, semireflective layer 220, analyte-responsive layer 230, and reflective layer 240 are discussed in further detail later herein, and are understood to be applicable to either of the exemplary embodiments disclosed above (with reference to FIGS. 2 and 3), except where specified to be applicable to a particular embodiment. Even though the same reference numbers are used to designate the above-referenced layers, those of ordinary skill in the art will readily appreciate that the layers so designated may have the same or different configurations and/or compositions. Various other layers, including for example tie layers, adhesion promoting layers, protective layers, cover layers, and the like, may be included in sensing element 2 as desired, as long as they do not unacceptably interfere with the functioning of sensing element 2. In addition, all designs, configurations and features of monitor 1 discussed herein, are understood to be applicable to either of the above embodiments unless stated otherwise.

Monitor 1 may comprise any suitable material and design that will accommodate, promote and/or enhance the functioning of sensing element 2. In some embodiments, monitor 1 may comprise a main body 100. In some embodiments, main body 100 may comprise a length and breadth that are generally greater than the thickness of main body 100, (e.g., generally as shown in FIGS. 1 and 1A). However, monitor 1 and main body 100 thereof may have any suitable design capable of presenting sensing element 2 such that air can be monitored. In particular, monitor 1 and main body 100 thereof, and any additional portions thereof, may be of suitable design to accommodate the various features and functionalities discussed herein.

Main body 100 of monitor 1 may be made of any suitable material comprising sufficient mechanical integrity, durability, etc. In some embodiments, main body 100 may be made injection molded using a suitable thermoplastic polymeric material. Various of the features of monitor 1 described later herein (spacing members, protrusions, posts, flanges, recesses, etc.) may be molded directly into, or along with, main body 100.

Particularly if sensing element 2 is of the general type depicted in FIG. 3, sensing element 2 may be positioned adjacent a portion of main body 100 of monitor 1, with substrate 210 facing toward main body 100 and analyte-permeable reflective layer 240 facing away from main body 100. In this configuration, shown in an exemplary manner in FIG. 4, incoming light rays 30 and/or light rays 31 and 32 may pass through portion 103 of main body 100 that is in overlapping relation with sensing element 2, so at least portion 103 of main body 100 should be sufficiently transparent to allow optical interrogation. (In some alternative embodiments, main body 100 may be designed to provide a direct pathway, e.g., a hole or opening for light the reach sensing element 2 without passing through main body 100, an example of which design is shown in FIG. 12.)

Such a configuration may have certain advantages, particularly if, as is often done, monitor 1 is placed upon or near a mounting surface 4 (e.g., a wall, the body of a person wearing monitor 1, etc.) as described previously. For example, such an arrangement may allow sensing element 2 to be optically interrogated (e.g., by visual inspection by a wearer or operator) from the outward-facing side (the side facing away from mounting surface 4) of main body 100 of monitor 1, while main body 100 of monitor 1 acts to at least partially shield sensing element 2 from direct contact with an analyte (or with any substance that may interfere with the monitoring of the desired analyte). As such, main body 100 of monitor 1 may be constructed of a material selected to be substantially impermeable to liquid-phase materials. The positioning of sensing element 2 in this position may also render sensing element less sensitive to temporary fluctuations (e.g., momentary locally high concentrations) in the amount of analyte in the monitored air. Of further advantage is that the outward-facing surface of portion 103 of main body 100 of monitor 1 through which it may be desired to pass light, may be cleaned of dirt, debris, liquids, and the like, without damaging sensing element 2.

It should also be noted that even if some of portion 103 of main body 100 is removed or missing as described above, analyte-responsive layer 230 of sensing element 2 may be at least partially shielded from the above-described undesired direct contact with an analyte or other substances, by substrate 210 which if present may be constructed of a material that is substantially impermeable to liquid-phase materials. In this case (e.g., as with the design of FIG. 12) it may be possible to remove debris from second major surface 212 of substrate 210 of sensing element 2, without damaging the other layers of sensing element 2.

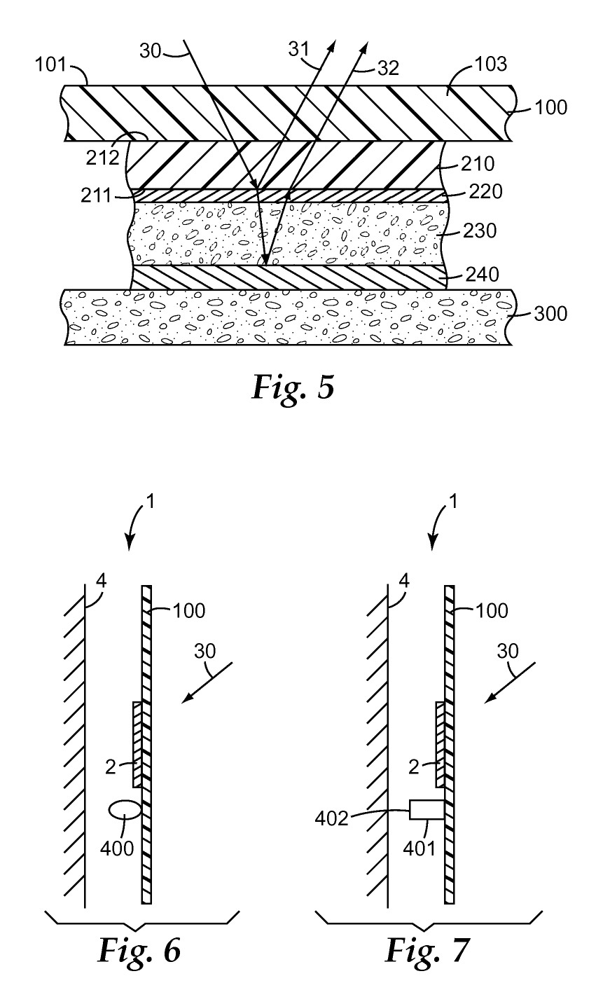

It may be of further advantage to include other components and/or designs of monitor 1 to enhance the protection of sensing element 2 from an undesirable type of contact with liquid analyte (e.g., direct contact with analyte that might result from being splashed or sprayed with liquid analyte) or with one or more other substances (e.g., liquids or solids) that might interfere with the functioning of sensing element 2. Thus, if (as in the exemplary designs of FIGS. 3 and 4) reflective layer 240 is analyte-permeable, it may be useful to provide a protective layer 300 adjacent analyte-permeable reflective layer 240, as shown in generic representation in FIG. 5. Protective layer 300 may comprise any material that is sufficiently (gas and/or vapor)-permeable so as to allow sufficient passage of a gas and/or vapor phase analyte to assure adequate response of sensing element 2, while substantially or completely preventing the passage of undesired liquid-phase materials. Thus, protective layer 300 may comprise any suitable porous material that allows passage of gas and/or vapor while substantially preventing passage of liquid. (In this context, substantially preventing passage of liquid means that while the protective layer might allow liquid to penetrate through the material upon the application of sufficiently high pressure as might be achieved by e.g. pumping, liquid will not penetrate through the layer in such events as incidental contact, pouring, splashing, etc.). Such materials may include for example porous and/or microporous membranes, nonwoven webs, woven fabrics, and the like. Such materials may be treated if desired so as to modify their wettability and/or or their ability to prevent the passage of liquid.

Protective layer 300 may also protect sensing element 2 from contact with solid materials (e.g., dust, pollen, and the like) that might interfere with the functioning of sensing element 2, e.g. by blocking or occluding analyte-permeable reflective layer 240.

At least a portion of protective layer 300 may be in direct contact with at least a portion of a surface of analyte-permeable reflective layer 240; or, space may be provided therebetween. At least a portion of protective layer 300 may be attached to at least a portion of analyte-permeable reflective layer 240; or, protective layer 300 may for example be attached to main body 100 of monitor 1, at one or more locations beyond the edges of sensing element 2. Protective layer 300 may extend somewhat beyond the edges of sensing element 2 (e.g., as shown in FIG. 5) to minimize the chance of any liquid penetrating laterally between protective layer 300 and main body 100 of monitor 1 so as to reach a side edge of analyte-responsive layer 230. In addition to this, or in place of this, features may be provided (e.g., molded) into main body 100 of monitor 1 to interact with the edges of protective layer 300 to provide such shielding. For example, main body 100 may comprise flanges that protrude away from main body 100 and that partially, substantially or completely surround the edges of sensing element 2, so as to minimize the chance of liquid material reaching an edge of sensing element 2.

Monitor 1 may be designed so as to enhance the ability of air to access sensing element 2 (such that any gas or vapor phase analyte of interest, if present in the air, can be most accurately monitored). Specifically, in a configuration in which sensing element 2 is between main body 100 of monitor 1 and mounting surface 4 (as shown in FIG. 1), provision may be made that access of air to analyte-permeable reflective layer 240 is not unacceptably blocked or obscured by mounting surface 4. Thus, in various embodiments, at least one spacing element 400 (shown in generic representation in FIG. 6) may be used to establish and/or maintain a gap or pathway between reflective layer 240 and mounting surface 4 and/or between main body 100 and mounting surface 4, so as to allow access of air to sensing element 2.

Spacing element 400 may take a variety of forms. For example, spacing element 400 may comprise a layer of analyte-permeable material that is placed adjacent sensing element 2 so as to be directly between sensing element 2 and mounting surface 4 when monitor 1 is placed adjacent (e.g., attached to, mounted on, hanging near, etc.) mounting surface 4. Such an analyte-permeable material may comprise a suitable porous material that allows passage of gas and/or vapor, and may include for example porous and/or microporous membranes, nonwoven webs, woven fabrics, and the like. In this configuration, the function of spacing element 400 and that of the above-described protective layer 300 may be combined in a single element 300/400 in an arrangement similar to that shown in FIG. 5. Such a combined protective/spacing element may be provided in any suitable way. For example, the element may be attached to sensing element 2 (e.g., to reflective layer 240 of sensing element 2), as long as such attachment does not unacceptably impact the functioning of sensing element 2. Or, the element may be attached to main body 100 of monitor 1, and be shaped so as to extend over at least a portion of sensing element 2.

Spacing element 400 need not necessarily be made of an intrinsically porous material as described above. For example, as shown in the exemplary design of FIG. 7, spacing element 400 may comprise one or more protrusions 401 (e.g., posts, that may be made of a solid material) that protrude from main body 100 of monitor 1, such that a terminal end 402 of protrusion 401 is positioned farther from main body 100 of monitor 1 than the farthest-protruding portion of sensing element 2 (which, in some configurations, may be analyte-permeable layer 240 of sensing element 2). Thus, when monitor 1 is positioned adjacent to mounting surface 4, terminal end 402 of protrusion 401 may contact mounting surface 4 and reduce the likelihood of sensing element 2 contacting mounting surface 4 and analyte-permeable reflective layer 240 being blocked or obscured thereby.

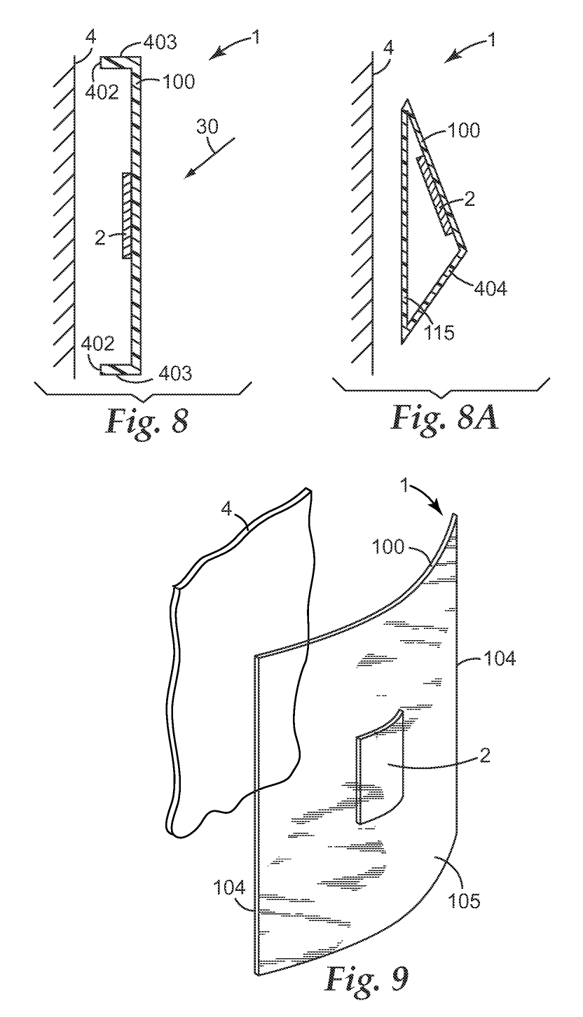

Rather than comprising one or more features that protrude from main body 100 of monitor 1 in the vicinity of sensing element 2, protrusions (s) 401 may, as shown in the exemplary design of FIG. 8, comprise one or more flanges 403 that extend from main body 100 (e.g., at or near the perimeter edges of monitor 1) such that a terminal end 402 of flange 403 is positioned further from main body 100 of monitor 1 than the farthest-protruding portion of sensing element 2. Flanges 403 may be present for example along generally some or all of the perimeter edges of main body 100 of monitor 1. Flanges 403 may also provide some protection to sensing element 2 against undesired contact (e.g., by splashing) with liquid substances. Flanges 403 may be interrupted by openings (e.g., rather than extending completely around the periphery of sensing element 2 in a continuous manner) so as to permit adequate access of air to sensing element 2.

In some embodiments, main body 100 of monitor 1 may be connected to other bodies, such one or more rear bodies/walls, side bodies/walls, etc. For example, as shown in an exemplary manner in FIG. 8A, monitor 1 may comprise main body 100, and one or more walls (e.g., sidewalls) 404 that connect main body 100 to rear body 115. In such a case, monitor 1 may take the form of a generally hollow structure. In such a case, when monitor 1 is positioned adjacent mounting surface 4, rear body 115 may be in close proximity to, and/or touching, mounting surface 4, with sensing element 2 being located on main body 100 as previously described. Air access into the space between main body 100 and rear body 115 can be provided via one or more spaces (e.g., interruptions, holes, perforations, etc.) in sidewall(s) 404. In some embodiments, one or more sidewalls 404 may be eliminated so as to allow air access. In some embodiments (e.g., as shown in FIG. 8A) main body 100 upon which sensing element 2 is located may be provided at an angle so as to enhance the viewing of sensing element 2.

In some embodiments, rather than or in addition to the providing of protrusions 401, main body 100 of monitor 1 may be provided in a nonplanar shape. Such a shape may comprise a curved shape (as shown in the exemplary design of FIG. 9). However, main body 100 does not have to comprise the smoothly curved shape of FIG. 9 (e.g., main body 100 may be comprised of two or more relatively planar, connected portions). In embodiments of this general type, when monitor 1 is placed adjacent mounting surface 4, terminal edges 104 of main body 100 of monitor 1 may contact mounting surface 4, with sensing element 2 being located on an interior portion of main body 100 away from terminal edges 104, thus unlikely to contact mounting surface 4. Sensing element 2 may be flexible as described herein thus in these embodiments may be able to be curved (e.g., as shown in FIG. 9) to match the curvature of main body 100 of monitor 1 (or, a relatively flat area may be provided in a portion of main body 100 of monitor 1 to receive sensing element 2).

The exemplary designs shown in FIGS. 7, 8, 8A, and 9 are just a few of the possible ways in which main body 100 of monitor 1 may comprise protruding features and/or may be curved, shaped, etc., so as to provide the desired condition that access of environmental air to sensing element 2 is not unacceptably blocked or obscured by contact of sensing element 2, or of certain portions of monitor 1, with mounting surface 4.

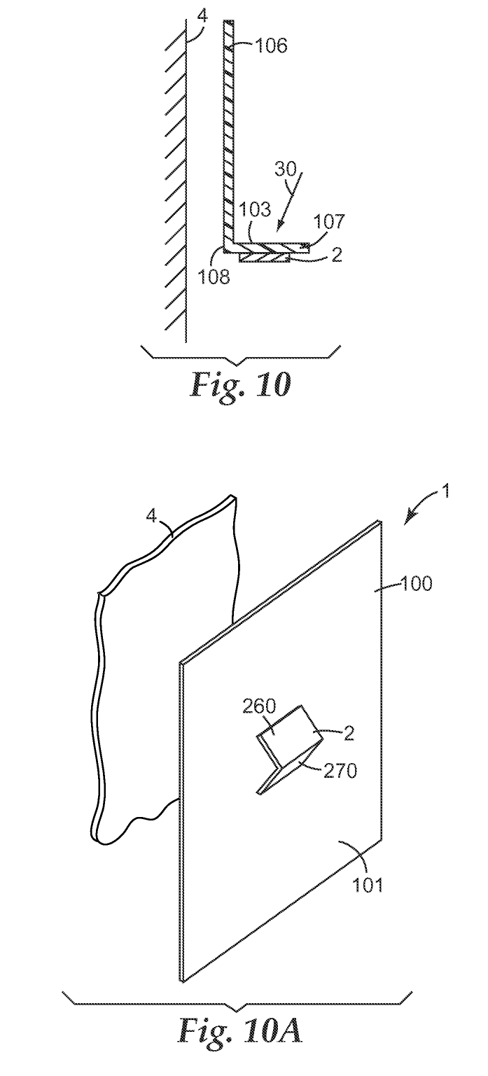

Another exemplary design of this general type is shown in FIG. 10. In embodiments incorporating this design, main body 100 comprises a first portion 106 that, when monitor 1 is in position adjacent mounting surface 4, is adjacent mounting surface 4 (with at least a part of portion 106 possibly in contact with mounting surface 4). Main body 100 comprises a second portion 107 that protrudes away from first portion 106, for example at an angle with respect thereto, such that sensing element 2, which is disposed on or within second portion 107, is less likely to contact mounting surface 4 in such a way as to prevent air from accessing sensing element 2. In the exemplary illustration of FIG. 10, second portion 107 protrudes from first portion 106 generally at a 90 degree angle. However, any suitable angle may be used.

In some embodiments, joint 108 between first portion 106 and second portion 107 of main body 100 can be hinged or deformable. In such configurations, monitor 1 may be produced with second portion 107 capable of being placed generally flush against first portion 106, which may allow monitor 1 to assume a generally flat configuration for packaging and storage, and to then be opened by the user into a configuration such as shown in FIG. 10, for use.

In the exemplary configuration of FIG. 10, with a sensing element of the type shown in FIG. 3 being used, sensing element 2 may be mounted under (with respect to the side view of FIG. 10) portion 107 of monitor 1, with sensing element 2 being optically interrogated by way of light passing through portion 103 of monitor 1. It is noted that the monitor configuration of FIG. 10 may have certain advantages in that it may provide enhanced ease of interrogating (viewing) sensing element 2 in the particular case that monitor 1 comprises a badge that is worn upon the chest of a person (with the wearer thus having to look down at monitor 1 to view sensing element 2). Locating sensing element 2 on a projecting portion 107 in this manner may reduce or negate the need for the wearer to move the badge into a generally horizontal position in order to view sensing element 2. (This type of monitor configuration may also be used with sensing elements of the type shown in FIG. 2. In such case it may be desirable to position sensing element 2 on the upper surface of projecting portion 107 rather than on the underside).

In still another embodiment, sensing element 2 may comprise a nonplanar shape which may be used to advantage in providing sensing element 2 on main body 100 of monitor 1 in such a position as to enhance air access to sensing element 2. For example, shown in exemplary manner in FIG. 10A is monitor 1 comprising sensing element 2 which comprises portion 260 and portion 270, that meet and connect at an angle, and at least one of which is attached directly or indirectly to monitor 1. In such case, particularly if sensing element 2 is designed such that analyte-permeable reflective layer 240 faces toward main body 100 of monitor 1, air access to analyte-permeable reflective layer 240 may be enhanced even though holes or perforations need not necessarily be present in any portion of monitor 1. In such a design, one of the portions (e.g., portion 270) may be fully functional, or it may comprise an extended portion of sensing element 2 that is not functional (for example, portion 270 may be comprised only of substrate 210). Other configurations of this general type are possible; for example, sensing element 2 may comprises a curved (e.g., smoothly curved and/or semicylindrical) shape.

It should be noted that there may be no clear dividing line between structures of the various general configurations described herein (e.g., the structures exemplified by FIGS. 8, 8A, 9, 10, and 10A), incorporating designs and features variously described as protrusions, flanges, sidewalls, rear bodies, shaped main bodies, main bodies with protruding portions, and so on. All such variations, and combinations thereof, are within the scope of the designs contemplated by the inventors. Any or all of the above approaches may also be used in combination with earlier-discussed protective layers 300.

In order to enhance the performance of sensing element 2, monitor 1 may be configured to establish, limit and/or control the angle at which sensing element 2 may be optically interrogated. That is, if sensing element 2 is to be optically interrogated by visual inspection, it may be desirable to restrict the viewing angle at which sensing element 2 may be viewed. This may enhance the fidelity of the optical interrogation, since the wavelength of light reflected from sensing element 2 may be affected to some extent by the angle at which the reflected light is emitted from sensing element 2. Such arrangements may, for example, allow a view of sensing element 2 from within an angle of, for example, ±30°, or ±15°, from a normal view (i.e., a view from a position perpendicular to the visible surface of sensing element 2).

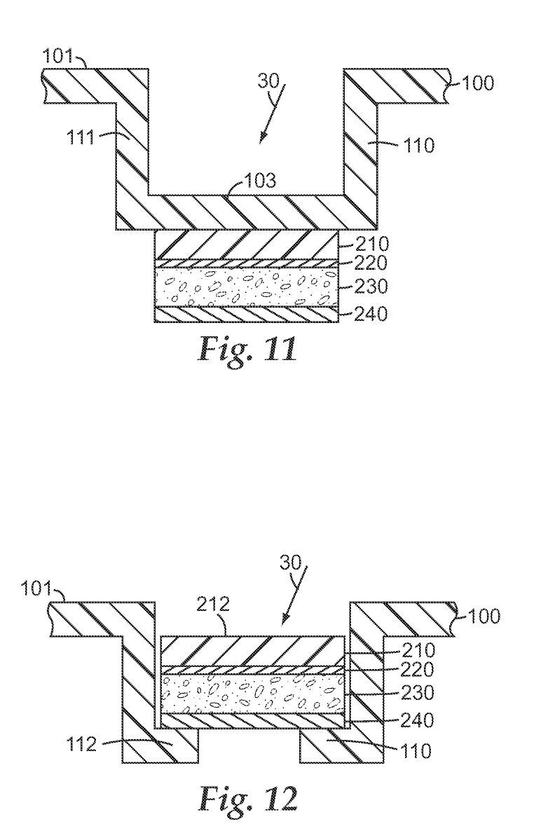

Thus, in various embodiments, main body 100 of monitor 1 may comprise a recess designed to position sensing element 2 such that a certain limited viewing angle is established. One such exemplary design is shown in FIG. 11, with sensing element 2 being positioned underneath recess 110 of main body 100 of monitor 1. Sidewalls 111 of recess 110 may serve to restrict the angle at which sensing element 2 may receive light rays 30 and/or the angle from which light rays emitted from sensing element 2 may be received (e.g., seen by a user). Although shown as generally parallel to each other in FIG. 11, sidewalls 111 may be tapered (angled) as desired to further control the desired viewing angle. Sidewalls 111 (and, possibly, the entirety of main body 100), may be opaque if desired.

In such recessed mounting of sensing element 2 on monitor 1, sensing element 2 may be positioned such that a portion 103 of main body 100 of monitor 1 is between sensing element 2 and incoming light 30 (as in FIG. 11). Other configurations are also possible. For example, in the design of FIG. 12, recess 110 is configured such that a direct path is provided for light to reach sensing element 2 without passing through main body 100 of monitor 1. In this particular design recess 110 further comprises flanges 112 that help hold sensing element 2 in place within recess 110, and yet allow air to access the majority of the area of analyte-permeable reflective layer 240 of sensing element 2.

Any of the previously described features such as protective layer 300, spacing element 400, a shaped main body 100, etc., may be used in combination with recesses that optimally define or restrict the viewing angle.

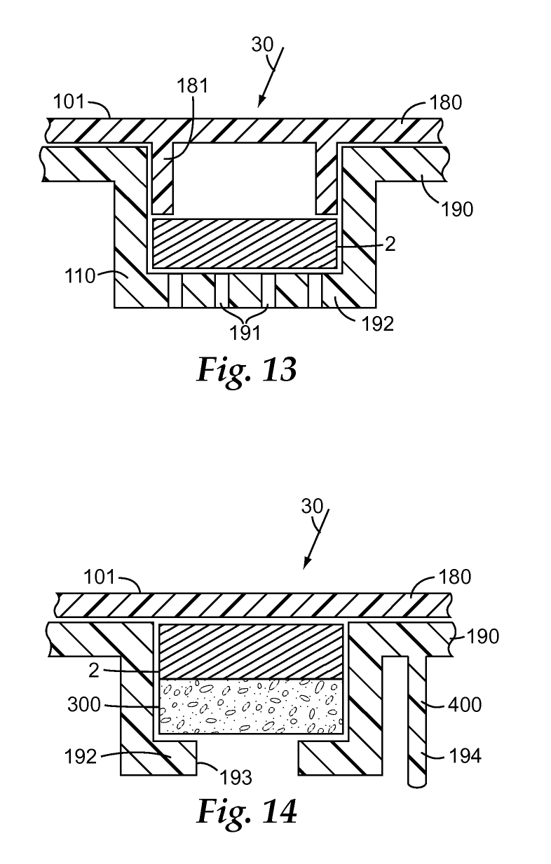

In order to enhance the performance of sensing element 2, it may be desirable to securely position (e.g., attach) sensing element 2 upon or within monitor 1 with minimal use, or no use, of adhesives (including for example pressure sensitive adhesives, liquid adhesives, thermally curable adhesives, radiation curable adhesives) that may contain small molecules that might interfere with the functioning of sensing element 2. In various embodiments, sensing element 2 may be attached to main body 100 of monitor 1 by one or more mechanical attachment devices including for example one or more clips, clamps, collars, screws, nails, rivets, bands, straps, and the like. In some embodiments main body 100 of monitor 1 may comprise an upper portion 180 (designating the portion that faces away from mounting surface when monitor 1 is positioned adjacent mounting surface 4) and a lower portion 190 (designating the portion that faces toward mounting surface 4 when monitor 1 is positioned adjacent mounting surface 4) that are fitted together so as to securely hold sensing element 2 in between at least a portion of upper portion 180 and a portion of lower portion 190. In the particular exemplary design of FIG. 13, sensing element 2 is positioned within recess 110 provided in lower portion 190, and upper portion 180 comprises one or more protrusions 181 that serve to hold sensing element 2 in place when portions 180 and 190 are fitted together (depending on e.g., the depth of recess 110, protrusions 181 may or may not be needed for this function). In the exemplary design of FIG. 13, perforations 191 are provided in portion 192 of lower portion 190 that underlies sensing element 2, to provide access of air to sensing element 2.

Other designs are possible in which main body 100 is comprised of upper portion 180 and lower portion 190, and may include any of the other components and features mentioned herein, such as protective layer 300, spacing element 400, shaped main body 100, etc. For example, in the exemplary design of FIG. 14 sensing element 2 is positioned within recess 110 provided in lower portion 190 and is held in place by upper portion 180 (which in this case does not comprise protrusions 181). Porous protective layer 300 is provided between sensing element 2 and underlying portion 192 of lower portion 190, which in this case (rather than comprising perforations as in FIG. 13) comprises flanges 193 (akin to those described with respect to FIG. 12) to hold sensing element 2 in place and yet allow air access to sensing element 2. Spacing element 400 (in this case, one or more posts 194) is provided that protrudes beyond spacing element 2 and beyond portion 192 of lower portion 190 that underlies sensing element 2, in order to allow air access.

Portions 180 and 190 may be fitted together and secured to each other by any suitable mechanism (not shown in FIGS. 13 and 14). For example, portions 180 and 190 may snap-fit together (optionally aided by securing features molded into portion 180 and/or 190), may be held together by external means (e.g., by the use of one or more mechanical attachments such as clamps, clips, bands, etc.), may be held together by ultrasonic bonding, and so on. Portions 180 and 190 may be bonded together by adhesives, by solvent-welding, and the like, as long as the components used do not unsatisfactorily affect sensing element 2, and/or as long as the bonding location is sufficiently remote from sensing element 2 that sensing element 2 is unaffected. In some particular embodiments, upper portion 180 and lower portion 190 of main body 100 may be provided as a single clamshell unit (e.g., connected to each other by a hinged portion such as a living hinge) configured so that the two portions can be closed together to secure sensing element 2 in place and can then be secured together as described.

Portions 180 and 190 may be separately made, e.g., by injection molding. Or, if portions 180 and 190 comprise a unitary set connected e.g. by a hinged portion, they may be formed as one unit. Various of the herein-described features of monitor 1 may be molded into portion 180 and/or portion 190, as desired.

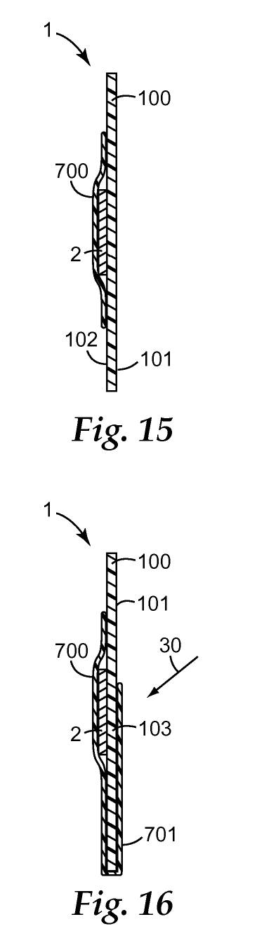

In order to enhance the performance of sensing element 2, it may be desirable to provide a removable barrier layer such that materials that might affect sensing element 2 do not enter sensing element 2, for example during assembly and/or storage of monitor 1. Thus, barrier layer 700 may be provided that partially, substantially, or completely covers sensing element 2. In various embodiments, barrier layer 700 may be in overlapping relation with, and/or in contact with, analyte-permeable reflective layer 240 (as in the exemplary embodiment shown in FIG. 15). Any material that possesses sufficiently low permeability to substances that it is desirable to hinder or prevent from entering sensing element 2 (e.g., organic gases, vapors, and/or liquids) may be used to form barrier layer 700. Such materials may include nonporous (solid) materials such as polyester film, polyolefin films such as polypropylene, metal foils such as aluminum foil, metal-coated polymeric films, and the like. Barrier layer 700 be placed such that it overlaps at least sensing element 2, and advantageously may extend beyond the perimeter edges of sensing element 2 a desired distance and contact main body 100 of monitor 1 if desired (as shown in the exemplary design of FIG. 15), in order to achieve more complete isolation of sensing element 2.

It may be advantageous to provide barrier layer 700 in such a manner that it is easy for a user to determine whether barrier layer 700 is still in position or has been removed. Thus, barrier layer 700 may be brightly colored (e.g., by use of pigment, or being printed upon) as opposed to being transparent. In the case in which a sensing element of the type of FIG. 3 is used (in which the analyte penetrates sensing element 2 from the opposite side of sensing element 2 from which sensing element 2 is optically interrogated), it may be advantageous for barrier layer 700 to overlap at least a portion of major surface 101 of monitor 1 for increased visibility. In some embodiments, barrier layer 700 may extend so as to cover (e.g., obscure) at least a part of portion 103 of main body 100 of monitor 1 through which sensing element 2 would otherwise be visible, as shown in the exemplary design of FIG. 16. (In this particular configuration, section 701 of barrier layer 700, being positioned on the outward side of monitor 1 need not have any particular barrier properties). Such a configuration might enhance the ability of a user to determine whether barrier layer 700 was still in place. In such a configuration, barrier layer 700 may wrap around a peripheral edge of main body 100 of monitor 1 (as in FIG. 16); or, a slot may be provided through which barrier layer 700 may penetrate.

Barrier layer 700 should be removable, for example by a user when it is desired to use monitor 1. Barrier layer 700 may be held in place by physical means (e.g., an elastic band, a bundling strap, etc.) or may be held using adhesive (again, as long as such adhesive does not unacceptably affect sensing element 2), as long as such means allow removal of barrier layer 700 when it is desired to use monitor 1.

Barrier layer 700 may be used in combination with any or all of the above features including protective layer 300, spacing element 400, shaped main body 100, viewing-angle restricting recess 110, and/or a main body comprising upper portion 180 and lower portion 190, any or all of which may in addition be used in combination with each other. In particular, if protective layer 300 is present, e.g., in contact with analyte-permeable reflective layer 240, barrier layer 700 may be placed in overlapping relation with protective layer 300 so as to isolate both protective layer 300 and sensing element 2, until barrier layer 700 is removed.

In addition to, or in place of, the use of barrier layer 700, monitor 1 may be packaged in an impermeable package (e.g., a pouch made of metal foil, metallized polymeric film, and the like) such that materials that might affect sensing element 2 do not enter sensing element 2, for example during assembly and/or storage of monitor 1.

In summary with respect to the design of monitor 1, various features, functionalities and attributes have been disclosed which may enhance the functioning of sensing element 2. While these features have been discussed individually for ease of understanding, it should understood that any and all possible combinations of these features are encompassed by the disclosures herein. Specifically, any or all features such as protective layers, spacing elements, shaped monitor main bodies, monitor main bodies with protruding sections, recesses for control of viewing angle, main bodies comprising upper and lower portions that are fitted together to securely hold the sensing element, and/or barrier layers to isolate the sensing element until use, may be used in combination according to the disclosures herein.

Sensing element 2 comprises analyte-responsive layer 230. Analyte-responsive layer 230 can be comprised of any material that is sufficiently permeable to an analyte of interest, and whose optical thickness changes sufficiently upon exposure to the analyte, to allow the desired functioning of sensing element 2 as described herein. In some embodiments, analyte-responsive layer comprises a porous material. In this context, “porous” means that the material comprises internal pores that are at least partially interconnected. Materials may be chosen, for example, with an average (mean) pore size (as characterized, for example, by sorption isotherm procedures) of less than about 100 nm. In various embodiments, materials may be chosen with an average pore size of less than 20 nm, less than about 10 nm, or less than about 2 nm. Layer 230 may be homogeneous or heterogeneous, and may, for example, be made from one or more inorganic components, one or more organic components, or a mixture of inorganic and organic components. Porosity can be obtained for example by forming foams from high internal phase emulsion materials, via carbon dioxide foaming to create a microporous structure, or by nanophase separation of polymer blends. Representative inorganic materials that may be used in layer 230 include metal oxides, metal nitrides, metal oxynitrides and other inorganic materials that can be formed into transparent (and if desired porous) layers of appropriate thickness for producing a suitable optical response such as a calorimetric change by optical interference. For example, layer 230 may comprise silicon oxides, silicon nitrides, silicon oxynitrides, aluminum oxides, titanium oxides, titanium nitride, titanium oxynitride, tin oxides, zirconium oxides, zeolites or combinations thereof.

Porous silica may be an especially desirable inorganic analyte-responsive layer material due to its robustness. Porous silicas may be prepared, for example, using a sol-gel processing route and made with or without an organic template. Exemplary organic templates include surfactants, e.g., anionic or nonionic surfactants such as alkyltrimethylammonium salts, poly(ethyleneoxide-co-propylene oxide) block copolymers and other surfactants or polymers that will be apparent to persons having ordinary skill in the art. The sol-gel mixture may be converted to a silicate and the organic template may be removed to leave a network of pores within the silica. A variety of organic molecules may also be employed as organic templates. For example, sugars such as glucose and mannose may be used as organic templates to generate porous silicates. Organo-substituted siloxanes or organo-bis-siloxanes may be included in the sol-gel composition to render the micropores more hydrophobic and limit sorption of water vapor. Plasma chemical vapor deposition may also be employed to generate porous inorganic analyte-responsive materials. This methodology generally involves forming a plasma from gaseous precursors, depositing the plasma on a substrate to form an amorphous random covalent network layer, and then heating the amorphous covalent network layer to form a porous amorphous random covalent network layer. Such methods and materials are described in further detail in International (PCT) Patent Application US 2008/078281, titled ORGANIC CHEMICAL SENSOR COMPRISING PLASMA-DEPOSITED MICROPOROUS LAYER, AND METHOD OF MAKING AND USING, which is incorporated by reference herein for this purpose.

In some embodiments, analyte-responsive layer 230 is comprised at least in part of organo-silicate materials, herein defined as compositions that are hybrids containing a covalently linked three dimensional silica network (—Si—O—Si—) with some organo-functional groups R, where R is a hydrocarbon or heteroatom substituted hydrocarbon group linked to the silica network by at least one Si—C bond. Such materials and methods of their making are described in further detail in U.S. Provisional Application Ser. No. 61/140,180, titled ORGANIC CHEMICAL SENSOR WITH MICROPOROUS ORGANOSILICATE MATERIAL, which is incorporated by reference herein for this purpose.

Representative organic materials that may be used to form layer 230 include polymers, copolymers (including block copolymers) and mixtures thereof prepared or preparable from classes of monomers including hydrophobic acrylates and methacrylates, difunctional monomers, vinyl monomers, hydrocarbon monomers (olefins), silane monomers, fluorinated monomers, hydroxylated monomers, acrylamides, anhydrides, aldehyde-functionalized monomers, amine- or amine salt-functionalized monomers, acid-functionalized monomers, epoxide-functionalized monomers and mixtures or combinations thereof.

In some embodiments, analyte-responsive layer 230 is made at least partially from components chosen from the family of materials comprising so-called “polymers of intrinsic microporosity” (hereafter called PIMs). Polymers in this family are described and characterized in, for example, “Polymers of Intrinsic Microporosity (PIMs): Robust, Solution-Processable, Organic Microporous Materials,” Budd et al., Chem. Commun., 2004, pp. 230-231; in “Polymers of Intrinsic Microporosity (PIMs),” McKeown et al., Chem. Eur. J., 2005, 11, No. 9, 2610-2620; in US Patent Application Publication 2006/0246273 to McKeown et al.; and in Published PCT application No. WO 2005/012397A2 to McKeown et al., all of which are incorporated by reference herein for this purpose.

PIMs can be formulated via the use of any combination of monomers that lead to a very rigid polymer within which there are sufficient structural features to induce a contorted structure. In various embodiments, PIMs can comprise organic macromolecules comprised of generally planar species connected by rigid linkers, said rigid linkers having a point of contortion such that two adjacent planar species connected by the linker are held in non-coplanar orientation. In further embodiments, such materials can comprise organic macromolecules comprised of first generally planar species connected by rigid linkers predominantly to a maximum of two other said first species, said rigid linkers having a point of contortion such that two adjacent first planar species connected by the linker are held in non-coplanar orientation. In various embodiments, such a point of contortion may comprise a spiro group, a bridged ring moiety or a sterically congested single covalent bond around which there is restricted rotation.

In a polymer with such a rigid and contorted structure, the polymer chains are unable to pack together efficiently, thus the polymer possesses intrinsic microporosity. Thus, PIMs have the advantage of possessing microporosity that is not significantly dependent on the thermal history of the material. PIMs thus may offer advantages in terms of being reproducibly manufacturable in large quantities, and in terms of not exhibiting properties that change upon aging, shelf life, etc.

For many applications, analyte-responsive layer 230 may be hydrophobic. This may reduce the chance that water vapor (or liquid water) will cause a change in the response of layer 230 and interfere with the detection of an analyte, for example, the detection of organic solvent vapors.

Further details and attributes of suitable materials useful for analyte responsive layer 230, and methods of making layer 230 from such materials, are described in e.g., U.S. Published Patent Application No. 2008/0063874, which is incorporated by reference herein for this purpose.

Sensing element 2 comprises reflective layer 240. In some embodiments, reflective layer 240 may be deposited (e.g., by various methods described herein) upon the surface of a previously formed analyte-responsive layer 230; or, reflective layer 240 may be deposited onto substrate 210, with analyte-responsive layer 230 then being deposited onto reflective layer 240.

Reflective layer 240 may comprise any suitable material that can provide sufficient reflectivity. Suitable materials for the reflective layer may include metals or semi-metals such as aluminum, chromium, gold, nickel, silicon, and silver. Other suitable materials that may be included in the reflective layer include metal oxides such as chromium oxide and titanium oxide. In some embodiments, the reflective layer may be at least about 90% reflective (i.e., at most about 10% transmissive), and in some embodiments, about 99% reflective (i.e., about 1% transmissive), at a wavelength of about 500 nm.

In some embodiments (e.g., incorporating the design of FIG. 3), reflective layer 240 may advantageously be permeable to an analyte of interest. This may be provided, for example, by forming reflective layer 240 of metal nanoparticles arranged in a morphology which approximates a stack of cannonballs or marbles and through which the analyte can permeate to reach and enter analyte-responsive layer 230.

A variety of metal nanoparticles may be employed. Representative metals include silver, nickel, gold, platinum and palladium and alloys containing any of the foregoing. Metals prone to oxidation when in nanoparticle form (e.g., aluminum) might be used but desirably would be avoided in favor of less air-sensitive metals. The metal nanoparticles may be monolithic throughout or may have a layered structure (e.g., a core-shell structure such as an Ag/Pd structure). The nanoparticles may, for example, have an average particle diameter of about 1 to about 100, about 3 to about 50 or about 5 to about 30 nm. The overall thickness of the metal nanoparticle layer may, for example, be less than about 200 nm or less than about 100 nm, and the minimum layer thickness may, for example, be at least about 5 nm, at least about 10 nm or at least about 20 nm. Although large diameter microparticles might be applied to form a monolayer, the nanoparticle layer typically will be several nanoparticles thick, e.g., at least 2 or more, 3 or more, 4 or more or 5 or more nanoparticles, and with up to 5, up to 10, up to 20 or up to 50 nanoparticles total thickness. The metal nanoparticle reflective layer may, for example, have a reflectance of at least about 40%, at least about 50% or at least about 60% at 500 nm. In various embodiments, the metal nanoparticle reflective layer may have a reflectance of at least about 80%, of at least about 90%, or of about 99%, at a wavelength of about 500 nm.

Solutions or suspensions of suitable metal nanoparticles are available from several suppliers, including Inkjet Silver Conductor ink AG-IJ-G-100-S1 (from Cabot Printable Electronics and Displays); SILVERJET™ DGH 50 and DGP 50 ink (from Advanced Nano Products); SVWO01, SVW102, SVE001, SVE102, NP1001, NP1020, NP1021, NP1050 and NP1051 inks from Nippon Paint (America); METALON™ FS-066 and JS-011 inks from Novacentrix Corp. and NP Series nanoparticle paste from Harima Chemicals, Inc. The metal nanoparticles may be borne in a variety of carriers, including water and organic solvents. The metal nanoparticles may also be borne in a polymerizable monomeric binder but desirably such binder is removed from the applied coating (using e.g., solvent extraction or sintering) so as to provide a permeable nanoparticle layer.

Layer 240 may be formed by applying a dilute coating solution or suspension of metal nanoparticles to analyte-responsive layer 230 and allowing the solution or suspension to dry to form permeable reflective layer 240. The dilution level may, for example, be such as to provide a coating solution or suspension that will provide a suitably liquid- or vapor-permeable metal nanoparticle layer, for example solids levels less than 30 wt. %, less than 20 wt. %, less than 10 wt. %, less than 5% or less than 4%. By diluting an as-received commercial metal nanoparticle product with additional solvent and applying and drying the dilute solution or suspension, an appreciably thin, liquid- or vapor-permeable layer can be obtained. A variety of coating techniques can be employed to apply the metal nanoparticle solution or suspension, including swabbing, dip coating, roll coating, spin-coating, spray coating, die coating, ink jet coating, screen printing (e.g., rotary screen printing), gravure printing, flexographic printing and other techniques that will be familiar to persons having ordinary skill in the art. Spin-coating may provide a thinner, more permeable coating than is obtained using other methods. Accordingly, some silver nanoparticle suspensions available at low solids levels (such as 5 wt. % SVW001 silver from Nippon Paint or 10 wt. % SILVERJET DGH-50 or DGP-50 from Advanced Nano Products) might be usable in the as-received form without further dilution if spin-coated at an appropriately high speed and temperature onto a suitable substrate. The metal nanoparticle layer may be sintered after it has been applied (e.g., by heating at about 125 to about 250 degrees C. for about 10 minutes to about 1 hour) so long as the sintering does not cause a loss of adequate permeability. It will be understood that the resulting reflective layer may no longer contain readily-identifiable nanoparticles, but that it may be referred to as a nanoparticle reflective layer to identify the manner in which it has been made.

Further details and attributes of suitable analyte-permeable materials useful for reflective layer 240, in particular metal nanoparticle materials, are described in e.g., U.S. Published Patent Application No. 2008/0063874, which is incorporated by reference herein for this purpose.

Sensing element 2 comprises semireflective layer 220. In various embodiments, semireflective layer 220 may be deposited (e.g., by various methods described herein) upon the surface of a previously formed analyte-responsive layer 230; or, semireflective layer 220 may be deposited onto substrate 210, with analyte-responsive layer 230 then being deposited onto semireflective layer 220.

Semireflective layer 220 by definition will comprise a lower reflectivity than does reflective layer 240, in order that the herein-described optical interrogation of sensing element 2 can be performed. Semireflective layer 220 can comprise any suitable material that can provide appropriate semireflectivity (e.g., when at an appropriate thickness). Suitable materials may include metals or semi-metals such as aluminum, chromium, gold, nickel, silicon, and silver. Other suitable materials that may include metal oxides such as chromium oxide and titanium oxide.

In various embodiments, semireflective layer 220 may be about 30 to about 70% reflective, or from about 40 to about 60% reflective, at a wavelength of about 500 nm.

In some embodiments (e.g., of the type incorporating the design of FIG. 2), semireflective layer 220 may advantageously be permeable to an analyte of interest. Thus, in this case it may be preferable to provide semireflective layer 220 at an appropriate thickness in order to provide appropriate reflectivity while permitting an analyte to permeate through semireflective layer 220 to reach and enter analyte-responsive layer 230. In some cases, a thickness in the general range of 5 nm may be desired (e.g., if semireflective layer 220 is deposited by vapor deposition to form a metal layer). Specific desired thicknesses will depend on the material used to form the layer, the analyte to be detected, and may be configured as necessary.

Semireflective layer 220 and reflective layer 240 may be made from similar or the same materials (e.g., deposited at different thicknesses or coating weights, so as to impart the desired differences in reflectivity). Semireflective layer 220 and reflective layer 240 may be continuous or discontinuous, as long as the properties of reflectivity and permeability that are desired for a particular application are provided. Further details of suitable semireflective layers and reflective layers, their properties and methods of making, are described for example in U.S. Published Patent Application 2008/0063874, incorporated by reference herein for this purpose.

Optional substrate 210 may be present in some embodiments. (In some embodiments, substrate 210 may serve as, or constitute a part of, main body 100 of monitor 1). If present, substrate 210 may be comprised of any suitable material (e.g., glass, plastic, etc.) capable of providing support for the multi-layer optical sensor. In embodiments in which light passes through substrate 210, substrate 210 should comprise sufficient transparency at the wavelengths of interest.

In some embodiments (e.g., as shown in FIG. 9), sensing element 2 may be nonplanar, e.g. curved. In such cases substrate 210 may be flexible, bendable, or crimpable. Such curvature of sensing element 2 might for example enhance the ability of a user to view sensing element 2 from an optimum viewing angle, and/or to allow a user to view the sensor from a larger range of viewing angles with minimal shift in color.

In some embodiments, a nonremovable masking layer may be provided to shield a portion of sensing element 2 from exposure to an analyte. Such a masking layer may for example be applied (e.g., coated) directly onto reflective layer 240 or may be bonded to reflective layer 240 via a tie layer or other adhesive layer. Such a masking layer may render the masked portion of sensing element 2 relatively unresponsive to analyte. In such a case, upon exposure to analyte the sensing element may display a signal in the form of a pattern (i.e., a reverse pattern of the masking layer on the semi-reflective layer). The signal pattern may have any desired configuration. In some embodiments, multiple sensing elements 2 may be provided, at least one with a masking layer, and at least one without a masking layer.

Monitor 1 comprising at least one sensing element 2 may be used to detect one or more organic analytes of interest. Typically, such analytes will comprise organic vapors and/or gases (e.g., volatile organic compounds) that may be present in air which is desired to be monitored. Representative organic analytes may include substituted or unsubstituted carbon compounds including alkanes, cycloalkanes, aromatic compounds, alcohols, ethers, esters, ketones, halocarbons, amines, organic acids, cyanates, nitrates, and nitriles, for example n-octane, cyclohexane, methyl ethyl ketone, acetone, ethyl acetate, carbon disulfide, carbon tetrachloride, benzene, toluene, styrene, xylenes, methyl chloroform, tetrahydrofuran, methanol, ethanol, isopropyl alcohol, n-butyl alcohol, t-butyl alcohol, 2-ethoxyethanol, acetic acid, 2-aminopyridine, ethylene glycol monomethyl ether, toluene-2,4-diisocyanate, nitromethane, acetonitrile, and the like.

Prior to use, sensing element 2 is typically substantially free of an analyte of interest. When not detecting an analyte of interest, sensing element 2 typically may display a first color, or may appear relatively colorless. Upon detecting an analyte, sensing element 2 may for example undergo a color change from a first color to a second color that is different from the first color, may undergo a color change from a first color to a colorless condition, or may undergo a color change from a colorless condition to a color-containing condition.

The optical response exhibited by sensing element 2 is typically observable in the visible light range and can be detected by the human eye. However, in some embodiments, sensing element 2 can be designed to respond to input radiation, and/or to exhibit a change in reflected radiation, in other wavelengths such as UV, infrared, or near infrared, for example. While optical interrogation may be performed by visual inspection (e.g., by a person), in some embodiments other interrogation methods may be used, including for example an external interrogation device such as a spectrophotometer, photo-detector, charge coupled device, photodiode, digital camera, and the like.

In some embodiments, two or more sensing elements 2 may be provided on monitor 1, so as to form an array. The array may be in any suitable configuration. For example, an array may comprise two or more sensing elements side by side, or sensing elements may be attached to, or constructed on, opposite sides of a main body 100 of monitor 1. The sensing elements within a given array may be of the same type or may be different. Such arrays might allow an expanded range of analyte concentrations to be monitored, for example.

In some embodiments, sensing element 2 may provide nonquantitative indications, (for example, indicating whether an analyte of interest is present, e.g., above a certain concentration). In some other embodiments, sensing element 2 may provide semiquantitative and/or quantitative information (e.g., an estimate or indication of the concentration of the analyte in the air that is being monitored).

In some embodiments, sensing element 2 may provide a cumulative indication (that is, an integrated indication that arises from the concentration of analyte in the monitored air over a period of time that may range up to a few hours). In some other embodiments, sensing element 2 may provide “real time” readings that arise from the instantaneous (e.g., over a period of a few minutes or less) concentration of analyte in the air.

In some embodiments, sensing element 2 may provide reversible indications, such that if the concentration of analyte in the air is reduced from a previously high level, sensing element 2 may change back to an condition indicative of a lower level of analyte.

As mentioned, sensing element 2 may function using ambient light and does not require an internal or external power source in order to function.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather by the structures described by the language of the claims, and the equivalents of those structures. To the extent that there is a conflict or discrepancy between this specification and the disclosure in any document incorporated by reference herein, this specification will control.

What is claimed is:

1. A monitor for detecting the presence of an organic analyte in ambient air, comprising:
a main body comprising at least one sensing element, the sensing element comprising at least a semireflective layer, an analyte-permeable reflective layer, and an analyte-responsive layer located therebetween,
wherein the sensing element is configured such that when the monitor is placed adjacent a mounting surface the analyte-permeable reflective layer faces toward the mounting surface,
and wherein the monitor comprises at least one spacing element arranged such that when the monitor is placed adjacent a mounting surface at least a portion of at least one spacing element comes in contact with the mounting surface and prevents the sensing element from coming into contact with the mounting surface.

2. The monitor of claim 1 wherein the spacing element comprises a porous, analyte-permeable material configured such that when the monitor is placed adjacent a mounting surface at least a portion of the porous material is positioned between at least a portion of the main body of the monitor and the mounting surface.

3. The monitor of claim 1 wherein the spacing element comprises a layer of porous, analyte-permeable material located adjacent at least a portion of the analyte-permeable reflective layer.

4. The monitor of claim 1 wherein the spacing element comprises at least one protrusion at least a portion of which protrudes from the main body past the analyte-permeable reflective layer of the sensing element.

5. The monitor of claim 4 wherein the main body comprises a perimeter and wherein the at least one protrusion comprises at least one flange at least a portion of which protrudes from the main body of the monitor past the analyte-permeable reflective layer of the sensing element and that extends at least partially around the perimeter of the main body and that comprises at least one opening that allows air to access the sensing element.

6. The monitor of claim 4 wherein the at least one protrusion comprises at least one post at least a portion of which protrudes from the main body of the monitor past the reflective layer of the sensing element.

7. The monitor of claim 1 wherein the main body comprises a first portion and a second portion that are fitted and secured together to hold the sensing element in place on the main body.

8. The monitor of claim 1 wherein the main body comprises a recess within which the sensing element is positioned and that comprises side walls that serve to limit the angle at which the sensing element may be viewed by a user.

9. The monitor of claim 1 wherein the monitor comprises a device that is worn by a person and wherein the mounting surface comprises a portion of the body or clothing of a person.

10. A monitor for detecting the presence of an organic analyte in ambient air, comprising:
a main body comprising at least one sensing element, the sensing element comprising at least a semireflective layer, an analyte-permeable reflective layer, and an analyte-responsive layer located therebetween,
wherein the sensing element is configured such that when the monitor is placed adjacent a mounting surface the analyte-permeable reflective layer faces toward the mounting surface,
and wherein the monitor comprises at least one protective layer adjacent the analyte-permeable reflective layer and which is permeable to gases and vapors but which substantially prevents the passage of liquids.

11. The monitor of claim 10 wherein the protective layer comprises a layer of porous material.

12. The monitor of claim 10 wherein the monitor further comprises at least one spacing element arranged such that when the monitor is placed adjacent a mounting surface at least a portion of at least one spacing element comes in contact with the mounting surface and prevents the sensing element from contacting the mounting surface.

13. The monitor of claim 10 wherein the main body comprises a first portion and a second portion that are fitted and secured together to hold the sensing element in place on the main body.

14. The monitor of claim 10 wherein the main body comprises a recess within which the sensing element is positioned and that comprises side walls that serve to limit the angle at which the sensing element may be viewed by a user.

15. The monitor of claim 10 wherein the main body comprises a nonplanar shape and an interior portion and wherein the sensing element is located on the interior portion of the main body.

16. The monitor of claim 10 wherein the main body comprises first portion and second portions, configured so that when the monitor is placed adjacent a mounting surface, the first portion is located adjacent the mounting surface and the second portion projects outward from the first portion in a direction opposite the mounting surface, and wherein the sensing element is located on the second portion of the main body of the monitor.

17. The monitor of claim 10 wherein the monitor comprises a device that is worn by a person and wherein the mounting surface comprises a portion of the body or clothing of a person.

18. A monitor for detecting the presence of an organic analyte in air, comprising:
a main body comprising at least one sensing element, the sensing element comprising at least a semireflective layer, an analyte-permeable reflective layer, and an analyte-responsive layer located therebetween,
wherein the monitor comprises a removable barrier layer located at least adjacent to, and in overlapping relation with, the analyte-permeable reflective layer of the sensing element and that substantially prevents the passage of gases, vapors and liquids into the sensing element.

19. The monitor of claim 18 wherein the sensing element comprises edges and wherein the removable barrier layer protrudes substantially beyond the edges of the sensing element.

20. The monitor of claim 18 wherein the main body comprises a light transmissive portion that is in overlapping relation with the semireflective layer of the sensing element and wherein a portion of the removable barrier layer is positioned adjacent at least a part of the portion of the main body that is in overlapping relation with the semireflective layer of the sensing element.

21. The monitor of claim 18 wherein the monitor comprises at least one spacing element arranged such that when the monitor is placed adjacent a mounting surface at least a portion of at least one spacing element comes in contact with the mounting surface and prevents the sensing element from contacting the mounting surface.

22. The monitor of claim 18 wherein the main body comprises a first portion and a second portion that are fitted and secured together to hold the sensing element in place on the main body.

23. The monitor of claim 18 wherein the main body comprises a recess within which the sensing element is positioned and that comprises side walls that serve to limit the angle at which the sensing element may be viewed by a user.

24. The monitor of claim 18 wherein the main body comprises a nonplanar shape and an interior portion and wherein the sensing element is located on the interior portion of the main body.

25. The monitor of claim 18 wherein the main body comprises first portion and second portions, configured so that when the monitor is placed adjacent a mounting surface, the first portion is located adjacent the mounting surface and the second portion projects outward from the first portion in a direction opposite the mounting surface, and wherein the sensing element is located on the second portion of the main body of the monitor.

26. A monitor for detecting the presence of an organic analyte in ambient air, comprising:
a main body comprising at least one sensing element, the sensing element comprising at least a semireflective layer, an analyte-permeable reflective layer, and an analyte-responsive layer located therebetween,
wherein the analyte-permeable reflective layer faces away from the main body and the semireflective layer faces toward the main body and is in overlapping relation with an area of the main body that is light-transmissive.

27. The monitor of claim 26 wherein the light transmissive area comprises an area of the main body that is comprised of a transparent material.

28. The monitor of claim 27 wherein the light transmissive area comprises an opening in the main body, and wherein the sensing element further comprises a transparent substrate that is adjacent the semireflective layer and that faces toward the opening in the main body.

29. The monitor of claim 26 wherein the monitor comprises at least one spacing element arranged such that when the monitor is placed adjacent a mounting surface at least a portion of at least one spacing element comes in contact with the mounting surface and prevents the sensing element from contacting the mounting surface.

30. The monitor of claim 26 wherein the main body comprises a first portion and a second portion that are fitted and secured together to hold the sensing element in place on the main body.

31. The monitor of claim 26 wherein the main body comprises a recess within which the sensing element is positioned and that comprises side walls that serve to limit the angle at which the sensing element may be viewed by a user.

32. The monitor of claim 26 wherein the main body comprises a nonplanar shape and an interior portion and wherein the sensing element is located on the interior portion of the main body.

33. The monitor of claim 26 wherein the main body comprises first portion and second portions, configured so that when the monitor is placed adjacent a mounting surface, the first portion is located adjacent the mounting surface and the second portion projects outward from the first portion in a direction opposite the mounting surface, and wherein the sensing element is located on the second portion of the main body of the monitor.

34. The monitor of claim 26 wherein the monitor comprises at least one protective layer adjacent the analyte-permeable reflective layer and which is permeable to gases and vapors but which substantially prevents the passage of liquids.

35. A monitor for detecting the presence of an organic analyte in ambient air, comprising:
a main body comprising at least one sensing element, the sensing element comprising at least a reflective layer, an analyte-permeable semi-reflective layer, and an analyte-responsive layer located therebetween, wherein the sensing element is configured such that when the monitor is placed adjacent a mounting surface the analyte-permeable semireflective layer faces away from the mounting surface,
and wherein the monitor comprises a removable barrier layer located at least adjacent to, and in overlapping relation with, the analyte-permeable semireflective layer of the sensing element and that substantially prevents the passage of gases, vapors and liquids into the sensing element.
